(19) United States
(12) Patent Application Publication
(10) Pub. No.: US 2023/0177353 A1
(43) Pub. Date: Jun. 8, 2023

(54) DECISION-MAKING SUPPORT APPARATUS, DECISION-MAKING SUPPORT METHOD, AND DECISION-MAKING SUPPORT PROGRAM

(71) Applicant: Hitachi, Ltd., Tokyo (JP)

(72) Inventors: Yasuyuki KUDO, Tokyo (JP); Hiroyuki MIZUNO, Tokyo (JP)

(21) Appl. No.: 17/979,173

(22) Filed: Nov. 2, 2022

(30) Foreign Application Priority Data
Dec. 2, 2021 (JP) 2021-196291

(51) Int. Cl. G06N 5/02

(52) U.S. Cl. CPC G06N 5/02

(57) ABSTRACT

An object of the present invention is to facilitate selection of an improvement effect. A decision-making support apparatus includes: a processor configured to execute a program; and a storage device configured to store the program, in which the storage device stores a score serving as a relative index between a plurality of intervention measures for each of the intervention measures, and the processor executes a selection process of receiving selection of a first improvement effect among a plurality of improvement effects related to the plurality of intervention measures, a first output process of outputting, within an adjustment range based on a first score of a first intervention measure for which the first improvement effect is selected by the selection process, adjustable information of the first score, an input process of receiving a score range set by an adjusted first score within the adjustment range, and a second output process of outputting, among the plurality of improvement effects, a second improvement effect of a second intervention measure having a second score included in the score range received by the input process.

### CLAIM OF PRIORITY

The present application claims priority from Japanese patent application JP 2021-196291 filed on Dec. 2, 2021, the content of which is hereby incorporated by reference into this application.

### BACKGROUND OF THE INVENTION

### 1. Field of the Invention

The present invention relates to a decision-making support apparatus, a decision-making support method, and a decision-making support program that support decision-making.

### 2. Description of the Related Art

JP-A-2014-81878 describes a decision-making support system in which how to change which value by combining a plurality of values which leads to improvement or deterioration of a current situation is present so that a user decides on a specific measure to improve the current situation. The decision-making support system includes: a setting unit configured to acquire, from a terminal, a variable whose value can be changed among variables used in an estimation model; a combination generation unit configured to generate a plurality of combinations of values to be estimated from the variable acquired from the terminal; an estimation unit configured to perform simulation using the plurality of combinations of values generated by the generation unit to obtain an estimation result; and a unit configured to output, to the terminal, a combination of values used as the estimation result by the estimation unit and visually display which estimation result is changed by a change in which value.

In JP-A-2014-81878, the number of estimation results displayed on the terminal is equal to a total number of combinations of values of changeable input variables. Therefore, when there are a large number of changeable input variables and values thereof, a large number of improvement effects are displayed. Therefore, as the changeable input variables and the values thereof increase, it becomes more difficult to narrow down an improvement effect of an intervention measure from predicted improvement effects of intervention measures.

### SUMMARY OF THE INVENTION

An object of the present invention is to facilitate selection of an improvement effect.

A decision-making support apparatus according to an aspect of the present invention disclosed in the present application includes: a processor configured to execute a program; and a storage device configured to store the program, in which the storage device stores a score serving as a relative index between a plurality of intervention measures for each of the intervention measures, and the processor executes a selection process of receiving selection of a first improvement effect among a plurality of improvement effects related to the plurality of intervention measures, a first output process of outputting, within an adjustment range based on a first score of a first intervention measure for which the first improvement effect is selected by the selection process, adjustable information of the first score, an input process of receiving a score range set by an adjusted first score within the adjustment range, and a second output process of outputting, among the plurality of improvement effects, a second improvement effect of a second intervention measure having a second score included in the score range received by the input process.

According to the representative embodiment of the present invention, it is possible to facilitate the selection of the improvement effect. Problems, configurations, and effects other than those described above are made clear by the following description of the embodiments.

### BRIEF DESCRIPTION OF THE DRAWINGS

FIG. 1 is a block diagram showing a hardware configuration example of a decision-making support apparatus.

FIG. 2 is a block diagram showing a functional configuration example of the decision-making support apparatus.

FIG. 3 is a diagram showing an example of a test measure DB.

FIG. 4 is a flowchart showing an example of a decision-making process procedure performed by the decision-making support apparatus.

FIG. 5 is a diagram showing a processing example of step S402 and step S403 according to a first embodiment.

FIG. 6 is a diagram showing an example of difference data in an outcome prediction value group.

FIG. 7 is a diagram showing an example of temporal variation information.

FIG. 8 is a diagram showing an example of a prediction information display screen.

FIG. 9 is a diagram showing a first display example of a prediction result display area.

FIG. 10 is a diagram showing a first display example of a result display adjustment area.

FIG. 11 is a diagram showing a processing example of step S402 and step S403 according to a second embodiment.

FIG. 12 is a diagram showing an example of grouping of K outcome prediction value groups.

FIG. 13 is a diagram showing an example of difference data according to the second embodiment.

FIG. 14 is a diagram showing a second display example of the prediction result display area.

FIG. 15 is a diagram showing a second display example of the result display adjustment area.

FIG. 16 is a diagram showing a processing example of step S403 and step S404 according to a third embodiment.

FIG. 17 is a diagram showing a third display example of the prediction result display area.

FIG. 18 is a diagram showing a third display example of the result display adjustment area.

FIG. 19 is a diagram showing an example of prediction result data obtained by a decision-making support apparatus according to a fourth embodiment.

### DESCRIPTION OF THE PREFERRED EMBODIMENTS

### First Embodiment

<Hardware Configuration Example of Decision-Making Support Apparatus>

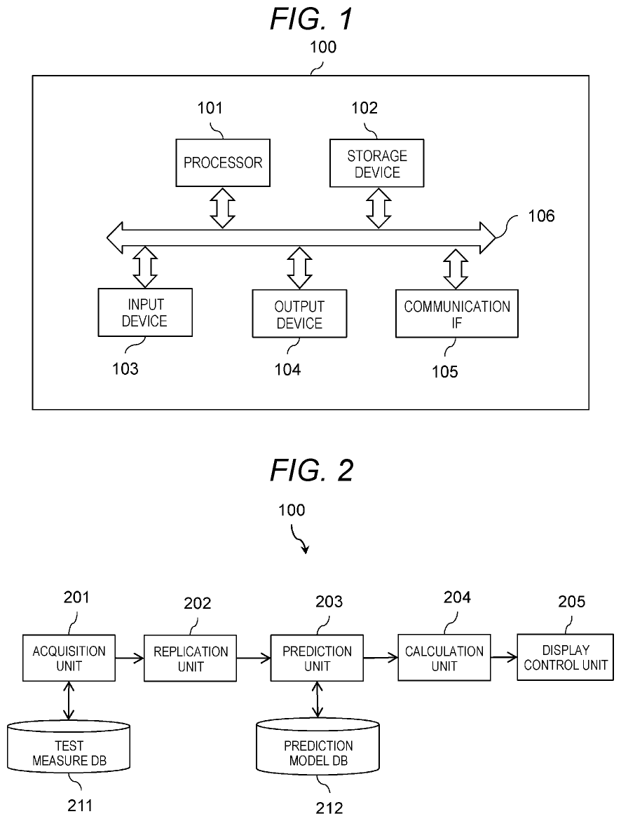

FIG. 1 is a block diagram showing a hardware configuration example of a decision-making support apparatus. A decision-making support apparatus 100 includes a processor 101, a storage device 102, an input device 103, an output device 104, and a communication interface (communication IF) 105. The processor 101, the storage device 102, the input device 103, the output device 104, and the communication IF 105 are connected by a bus 106. The processor 101 controls the decision-making support apparatus 100. The storage device 102 serves as an operation area of the processor 101. The storage device 102 is a non-transitory or temporary recording medium that stores various programs and data. Examples of the storage device 102 include a read only memory (ROM), a random access memory (RAM), a hard disk drive (HDD), and a flash memory. The input device 103 inputs data. Examples of the input device 103 include a keyboard, a mouse, a touch panel, a numeric keypad, a scanner, a microphone, and a sensor. The output device 104 outputs data. Examples of the output device 104 include a display, a printer, and a speaker. The communication IF 105 is connected to a network and transmits and receives data.

<Functional Configuration Example of Decision-Making Support Apparatus>

FIG. 2 is a block diagram showing a functional configuration example of the decision-making support apparatus. The decision-making support apparatus 100 includes an acquisition unit 201, a replication unit 202, a prediction unit 203, a calculation unit 204, a display control unit 205, a test measure DB 211, and a prediction model DB 212. Specifically, the acquisition unit 201, the replication unit 202, the prediction unit 203, the calculation unit 204, and the display control unit 205 are implemented, for example, by causing the processor 101 to execute a program stored in the storage device 102 shown in FIG. 1. Specifically, the test measure DB 211 and the prediction model DB 212 are stored in, for example, the storage device 102 shown in FIG. 1 or the storage device 102 of a computer that can communicate with the decision-making support apparatus 100, and can be accessed by the processor 101.

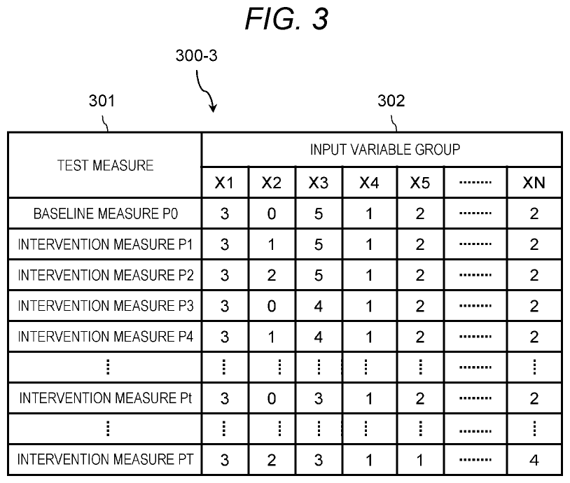

The test measure DB 211 stores test measure data for a certain number of repeated times. Details of the test measure DB 211 will be described later with reference to FIG. 3.

The prediction model DB 212 stores a prediction model group. The prediction model group includes the same M (M is an integer of 2 or more) prediction models PMa1 to PMaM. In a case where the prediction models PMa1 to PMaM are not distinguished from each other, they are expressed as a prediction model PMam. m is an integer satisfying 1≤m≤M, and is a number of repeated times m, which will be described later. The prediction model PMam is, for example, a neural network model. In addition, it is assumed that learning of the prediction model PMam has been completed in advance using training data having input variables of the same kind as those of test measures. An outcome prediction value, which is a numerical value of an outcome output by the prediction model PMam, is in a range of 0% to 100%.

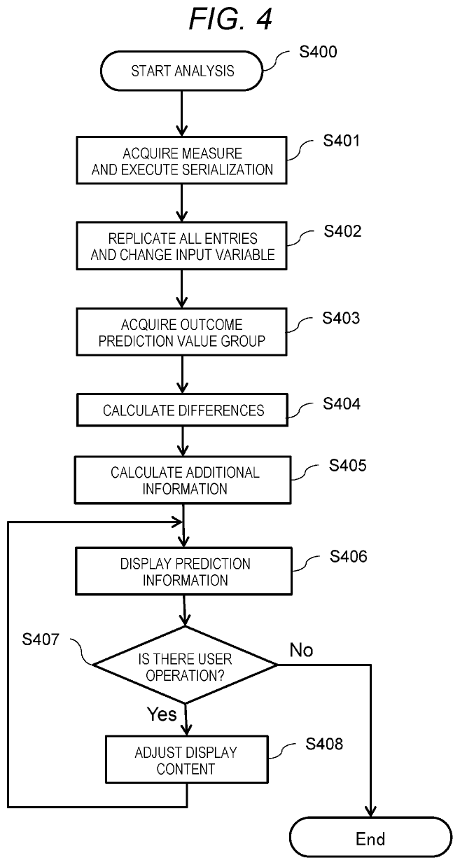

The acquisition unit 201 acquires test measure data from the test measure DB 211. The replication unit 202 replicates the test measure data acquired by the acquisition unit 201. The prediction unit 203 inputs replicated test measure data to the prediction models PMa1 to PMaM and outputs a prediction result. The calculation unit 204 calculates difference data and additional information. The display control unit 205 generates prediction information and outputs the prediction information in a displayable manner. An output destination of the prediction information is a display device that is an example of the output device 104 or a display device of a computer that can communicate with the decision-making support apparatus 100. The display control unit 205 adjusts the prediction information by an operation input using the input device 103 or the input device 103 of a computer that can communicate with the decision-making support apparatus 100, and outputs adjusted prediction information in a displayable manner. Specific processing of the acquisition unit 201, the replication unit 202, the prediction unit 203, the calculation unit 204, and the display control unit 205 will be described later with reference to FIG. 4.

<Test Measure DB>

FIG. 3 is a diagram showing an example of the test measure DB. The test measure DB 211 is a database that defines an input variable for a test measure, and is prepared in advance. The test measure DB 211 stores test measure data 300-3 having a test measure 301 and an input variable group 302 as fields. The test measure 301 includes a baseline measure P0 and T (T is an integer of 1 or more) intervention measures P1 to PT. The baseline measure P0 is a test measure serving as a reference for the intervention measures P1 to PT. Specifically, for example, the intervention measures P1 to PT are the test measure 301 obtained by changing a value of the input variable group 302 with respect to the baseline measure P0.

In a case where the baseline measure P0, the intervention measures P1, P2, . . . , and PT are not distinguished from each other, they are expressed to as a measure Pt (t is an integer satisfying 0≤t≤T). In addition, in a case where the intervention measures P1, P2, . . . , and PT are not distinguished from each other, they are expressed as an intervention measure Pt (t is an integer satisfying 1≤t≤T).

The input variable group 302 includes N (N is an integer of 1 or more) input variables X1 to XN that characterize the test measure 301, and values of the input variables X1 to XN are stored in respective entries of the test measure 301. The input variables X1 to XN include time-related variables. For example, one input variable (for example, X1) of the input variables X1 to XN is the number of repeated times m. The number of repeated times m is a numerical value indicating how many times the test measure 301 repeatedly encounters the same situation or the same intervention at present. In FIG. 3, as an example, it is assumed that the number of repeated times m is 3. The value “3” of the input variable X1 in the test measure data 300-3 stored in the test measure DB 211 is referred to as a base number of times.

<Decision-Making Process Procedure>

FIG. 4 is a flowchart showing an example of a decision-making process procedure performed by the decision-making support apparatus 100.

Step S400: The decision-making support apparatus 100 receives, via the input device 103, an input instruction input by a user and indicating the start of outcome prediction analysis, and starts data processing.

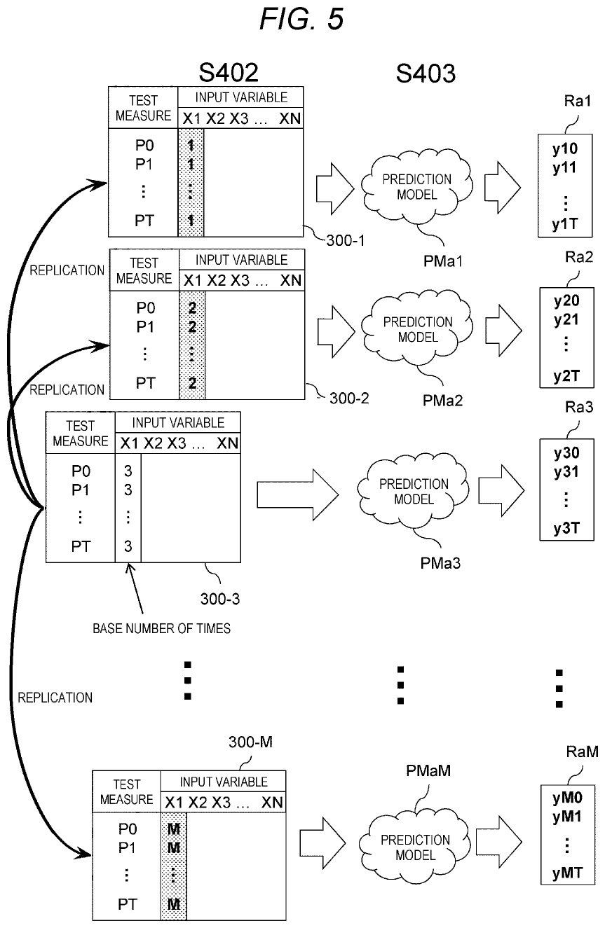

Step S401: The decision-making support apparatus 100 causes the acquisition unit 201 to acquire, from the test measure DB 211, (T+1) test measures 301, that is, data of entries of the baseline measure P0 and T intervention measures P1 to PT. Next, the decision-making support apparatus 100 causes the acquisition unit 201 to execute serialization processing of the test measure 301 so as to input the acquired (T+1) test measures 301 to the prediction model PMam. For example, the decision-making support apparatus 100 causes the acquisition unit 201 to shape test measure data 300 so that the baseline measure P0, and the intervention measures P1, P2, . . . , and PT are input to the prediction model in a time division manner in this order. Hereinafter, a specific description will be given with reference to FIG. 5.

FIG. 5 is a diagram showing a processing example of step S402 and step S403 according to the first embodiment.

Step S402: The decision-making support apparatus 100 causes the replication unit 202 to replicate all entries of the serialized test measures 301 (P0 to PT) in (M−1) pieces of test measure data, so as to obtain test measure data 300-1, 300-2, 300-4, . . . , and 300-M.

For each of the replicated (M−1) pieces of test measure data 300-1, 300-2, 300-4, . . . , and 300-M, the decision-making support apparatus 100 changes only the value m (number of repeated times) of the input variable X1 in all entries of the test measures 301 (P0 to PT). For example, the decision-making support apparatus 100 changes the value of the input variable X1 in the test measure 301 to a value up to M (except for “3” which is a base number of times) in ascending order from 1, for each of the (M−1) pieces of test measure data 300-1, 300-2, 300-4, . . . , and 300-M.

Specifically, for example, the decision-making support apparatus 100 causes the replication unit 202 to change, among the (M−1) test measures 301 excluding the test measure 301 before change shown in FIG. 3, the value of the input variable X1 of the first test measure 301 to “1”, the value of the input variable X1 of the second test measure 301 to “2”, the value of the input variable X1 of the fourth test measure 301 to “4”, . . . , and the value of the input variable X1 of the i-th test measure 301 to “i”, . . . , and the value of the input variable X1 of the M-th test measure 301 to “M”.

Step S403: The decision-making support apparatus 100 causes the prediction unit 203 to acquire the M prediction models PMA1 to PMaM from the prediction model DB 212, and to sequentially input the M pieces of test measure data 300-1 to 300-M to the respective prediction models PMa1 to PMaM. That is, the test measure data 300-1 to 300-M having different values of the number of repeated times for the input variable X1 are input to the respective M prediction models PMa1 to PMaM. Then, the decision-making support apparatus 100 causes the prediction unit 203 to acquire M outcome prediction value groups Ra1 to RaM sequentially predicted from the M prediction models PMa1 to PMaM.

Each of the outcome prediction value groups Ra1 to RaM is a set of (T+1) outcome prediction values. For example, the outcome prediction value group Ra1 includes an outcome prediction value y10 of the baseline measure P0, an outcome prediction value y11 of the intervention measure P1, . . . , and an outcome prediction value y1T of the intervention measure PT, at the number of repeated times m=1.

The outcome prediction value group Ra2 includes an outcome prediction value y20 of the baseline measure P0, an outcome prediction value y21 of the intervention measure P1, . . . , and an outcome prediction value y2T of the intervention measure PT, at the number of repeated times m=2. The outcome prediction value group Ra3 includes an outcome prediction value y30 of the baseline measure P0, an outcome prediction value y31 of the intervention measure P1, . . . , and an outcome prediction value y3T of the intervention measure PT, at the number of repeated times m=3 (base number of times). The same applies to the outcome prediction value group Ra4 and the subsequent groups, and the outcome prediction value group RaM includes an outcome prediction value yM0 of the baseline measure P0, an outcome prediction value yM1 of the intervention measure P1, . . . , and an outcome prediction value yMT of the intervention measure PT, at the number of repeated times m=M.

In a case where the outcome prediction value groups Ra1 to RaM are not distinguished from each other, they are simply expressed as an outcome prediction value group Ram. Similarly, the (T+1) outcome prediction values in the outcome prediction value group Ram are also expressed as an outcome prediction value ym0 of the baseline measure P0, an outcome prediction value ym1 of the intervention measure P1, . . . , and an outcome prediction value ymT of the intervention measure PT, respectively, at the number of repeated times m. In addition, in a case where the outcome prediction value ym0 of the baseline measure P0, the outcome prediction value ym1 of the intervention measure P1, . . . , and the outcome prediction value ymT of the intervention measure PT at the number of repeated times m=M are not distinguished from each other, they are simply expressed as an outcome prediction value ymt.

Step S404: The decision-making support apparatus 100 causes the calculation unit 204 to calculate differences dm0 to dmT between the outcome prediction value ym0 of the baseline measure P0 and each of the (T+1) outcome prediction values including the outcome prediction value ym0 of the baseline measures P0, the outcome prediction value ym1 of the intervention measure P1, . . . , and the outcome prediction value ymT of the intervention measures PT, for the outcome prediction value group Ram at the number of repeated times m.

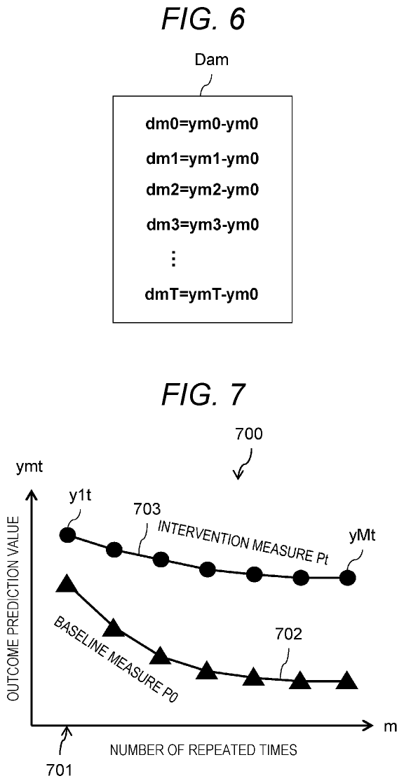

FIG. 6 is a diagram showing an example of difference data in the outcome prediction value group Ram. Difference data Dm in the outcome prediction value group Ram includes the differences dm0 to dmT. In a case where the differences dm0 to dmT are not distinguished from each other, they are expressed as a difference dm. The difference data Dm is calculated for the outcome prediction value group Ram. The difference data Dm is used for improvement effect ranking, which will be described later.

Step S405: Returning to FIG. 4, the decision-making support apparatus 100 causes the calculation unit 204 to calculate additional information for each outcome prediction value group Ram based on the outcome prediction value group Ram. The additional information includes temporal variation information of the outcome prediction value group Ram and a temporal variation score of the outcome prediction value group Ram.

FIG. 7 is a diagram showing an example of the temporal variation information. As shown in FIG. 7, temporal variation information 700 can be displayed graphically. A horizontal axis of a graph 701 represents the number of repeated times m (input variable X1), and a vertical axis thereof represents the outcome prediction value ymt at the number of repeated times m.

Base temporal variation data 702 is data indicating a temporal characteristic of the baseline measure P0. Specifically, for example, the base temporal variation data 702 is data obtained by plotting the outcome prediction values y10, y20, y30, . . . , and yM0 (M=7 in FIG. 7) of the respective baseline measures P0 of the outcome prediction value groups Ra1 to RaM having different number of repeated times m in order of the number of repeated times (represented by ▴ in FIG. 7).

Intervention temporal variation data 703 is data indicating a temporal characteristic of the intervention measure Pt. Specifically, for example, the intervention temporal variation data 703 is data obtained by plotting the outcome prediction values y1t, y2t, y3t, . . . , and yMt (M=7 in FIG. 7) of the respective intervention measures Pt of the outcome prediction value groups Ra1 to RaM having different number of repeated times m in order of the number of repeated times (represented by ● in FIG. 7). The intervention temporal variation data 703 exists for each of the intervention measures P1 to PT.

In addition, the temporal variation score is calculated, for the intervention measure Pt, by the following formula (1) using, for example, the outcome prediction value y1t when the number of repeated times m is 1 and the outcome prediction value yMt when the number of repeated times m is M. SCt is a temporal variation score (unit is [%]) for the intervention measure Pt.

SCt=(|y1t−yMt|/y1t)×100 (1)

The temporal variation score SCt is calculated for each of the intervention measures P1 to PT. The temporal variation score SCt has a larger value as |y1t−yMt| is larger.

Step S406: Returning to FIG. 4, the decision-making support apparatus 100 causes the display control unit 205 to generate and display the prediction information. The prediction information is displayed on a display device, which is an example of the output device 104.

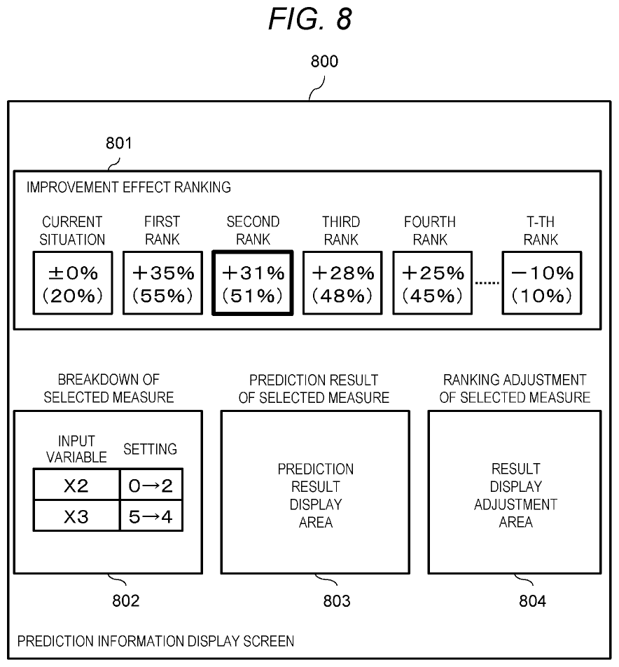

FIG. 8 is a diagram showing an example of a prediction information display screen. A prediction information display screen 800 is a display screen that displays the prediction information, and includes an improvement effect ranking display area 801, a breakdown display area 802 for a selected intervention measure, a prediction result display area 803, and a result display adjustment area 804.

The improvement effect ranking display area 801 is an area that displays, as the prediction information, improvement effect ranking at the base number of times (m=3).

The improvement effect ranking is a set of improvement effects in which the intervention measures Pt are ranked in descending order of the improvement effect at the base number of times (m=3). Specifically, for example, the decision-making support apparatus 100 ranks the intervention measures Pt from first rank to T-th rank in descending order of the difference dm at the base number of times (m=3). For example, the difference dm of a first-ranked intervention measure Pt is “+35%”.

Further, in each rank, the numerical value in parentheses is the outcome prediction value ymt of the intervention measure Pt at the base number of times (m=3). For example, the outcome prediction value ymt of the first-ranked intervention measure Pt is “55%”. At least one of the difference dm and the outcome prediction value ymt is sufficient for the improvement effect of the intervention measure Pt.

The “current situation” at a left end in the improvement effect ranking display area 801 includes the difference dm0 (±0%) and the outcome prediction value ym0 (20%) of the baseline measure P0 at the base number of times (m=3).

The user can select the improvement effect of the t-th-ranked intervention measure Pt by operating the input device 103.

The breakdown display area 802 of a selected intervention measure is an area that displays, as the prediction information, a breakdown of the intervention measure (selected intervention measure) Pt for which an improvement effect is selected in the improvement effect ranking display area 801. It is assumed that the user operates the input device 103 to select, for example, a second-ranked improvement effect (indicated by a thick frame) in the improvement effect ranking display area 801 as a first improvement effect.

In this case, the decision-making support apparatus 100 acquires, from the test measure DB 211, values of the input variables X1 to XN related to the intervention measure Pt of a selected rank (first improvement measure Pt) and values of the input variables X1 to XN related to the baseline measure P0 at the base number of times (m=3). Then, the decision-making support apparatus 100 displays, on the breakdown display area 802 of the selected intervention measure Pt, the values of the input variables X1 to XN related to the baseline measure P0 as values before the change (on a start side of an arrow) and the values of the input variables X1 to XN related to the intervention measure Pt of the selected rank (on an end side of the arrow).

The decision-making support apparatus 100 does not have to display an input variable that is not changed between the intervention measure Pt of the selected rank and the baseline measure P0. In FIG. 8, a breakdown in which the value of the input variable X2 is changed from “0” to “2” and the value of the input variable X3 is changed from “5” to “4” is displayed.

The prediction result display area 803 is an area that displays, as the prediction information, the temporal variation information 700 indicating a prediction result among the additional information calculated in step S405. It is assumed that the user operates the input device 103 to select, for example, the second-ranked improvement effect (indicated by a thick frame) in the improvement effect ranking display area 801 as the first improvement effect.

In this case, the decision-making support apparatus 100 acquires the base temporal variation data 702 and the intervention temporal variation data 703 of the intervention measure Pt of the selected rank (first improvement measure Pt) as the temporal variation information 700 at the base number of times (m=3), and displays the temporal variation information 700 on the prediction result display area 803.

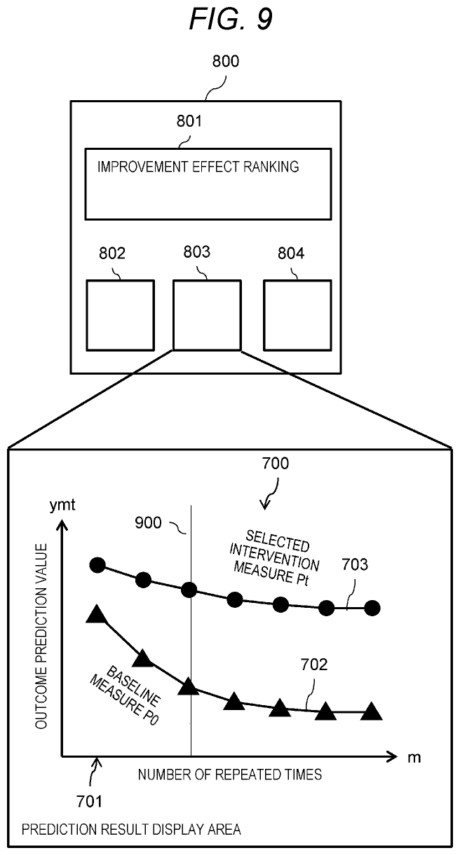

FIG. 9 is a diagram showing a first display example of the prediction result display area 803. In the temporal variation information 700, a vertical line 900 indicates the base number of times (m=3). Accordingly, the user can visually recognize where the base number of times (m=3) is in the temporal variation information 700 being displayed.

Returning to FIG. 8, the result display adjustment area 804 is an area that displays, as the prediction information, a user interface that enables adjustment of the value of the temporal variation score SCt among the additional information calculated in step S405.

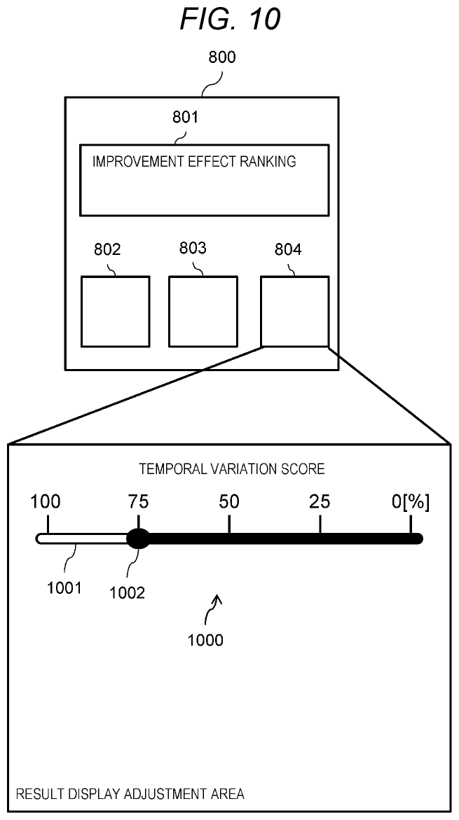

FIG. 10 is a diagram showing a first display example of the result display adjustment area 804. A user interface 1000 that enables adjustment of the value of the temporal variation score SCt, which is a first score, is displayed on the result display adjustment area 804. The user interface 1000 includes a numerical axis 1001 and a slider 1002.

The numerical axis 1001 is a slider bar having 0% at a right end and 100% at a left end. The slider 1002 is movable on the numerical axis 1001 by the operation of the input device 103 by the user. A default position of the slider 1002 is 100%. The position of 100% corresponds to the temporal variation score SCt of the selected intervention measure Pt. Since a percentage value indicated by the slider 1002 decreases as the slider 1002 is moved to the right, the temporal variation score SCt also decreases. A range from 0% to a percentage indicating the current position of the slider 1002 is referred to as a score range (indicated by a black thick line on the numerical axis 1001 in FIG. 10).

The improvement effect of the intervention measure Pt having the temporal variation score SCt within the score range is selected as a display target in the improvement effect ranking display area 801. In the example of FIG. 10, since the slider 1002 is positioned at 75% of the numerical axis 1001, a range indicated by black from 0% to 75% is set as the score range.

That is, the decision-making support apparatus 100 causes the display control unit 205 to set a second improvement effect of a second intervention measure Pt having a second score, which is a temporal variation score (0.75×SCt to 0 in the example of FIG. 10) equal to or less than the numerical value (75% in the example of FIG. 10) of the current position of the slider 1002, as the display target of the improvement effect ranking display area 801. Therefore, as the user moves the slider 1002 to the right, the number of intervention measures Pt displayed in the improvement effect ranking display area 801 decreases. As a result, the displayed intervention measure Pt is the intervention measure Pt having the temporal variation score SCt smaller than that of the intervention measure Pt which is not displayed, that is, having high sustainability.

In addition, since a third intervention measure Pt corresponding to a temporal variation score outside the score range indicated by black is not displayed, the number of options when selecting the intervention measure Pt is reduced, and the burden on the user is reduced.

In addition, in a case where the number of rankings to be displayed is set in advance, the decision-making support apparatus 100 may automatically perform score adjustment in accordance with the number of displayed rankings, and output the adjustment result as the score range of the temporal variation score SCt.

Steps S407 and S408: Returning to FIG. 4, when there is a user operation (step S407: Yes), the decision-making support apparatus 100 causes the display control unit 205 to adjust the display content of the prediction information display screen 800 (step S408), and to display adjusted prediction information on the prediction information display screen 800 (step S406).

Specifically, the user operation in step S407 is, for example, selection of the improvement effect of the t-th-ranked intervention measure Pt in the improvement effect ranking display area 801 described above or movement operation of the slider 1002 in the result display adjustment area 804.

The display content adjustment of the prediction information display screen 800 in step S408 is the display of the temporal variation information 700 on the selected intervention measure Pt in the prediction result display area 803 when the user operation in step S407 is the selection of the improvement effect of the t-th-ranked intervention measure Pt in the improvement effect ranking display area 801, and is the improvement effect (difference dm, outcome prediction value ymt) on the intervention measure Pt having the temporal variation score SCt equal to or less than the numerical value of the current position of the slider 1002 in the improvement effect ranking display area 801 when the user operation in step S407 is the movement operation of the slider 1002 in the result display adjustment area 804. The adjustment result in step S408 is stored in the prediction result DB, and can be called in response to a request from the user.

In a case where there is no user operation (step S407: No), the decision-making support apparatus 100 ends the decision-making process when an end condition (for example, pressing of an end button (not shown)) is satisfied.

As described above, in the decision-making support apparatus 100 according to the first embodiment, the prediction result of the intervention measure Pt that matches these conditions is displayed when the user sets the range of the temporal variation score SCt which is the additional information. That is, the user can confirm the sustainability of the intervention measure Pt using two evaluation items, i.e., the outcome prediction value ymt and the temporal variation score SCt. This makes it possible to select an optimum intervention measure Pt even when there are a large number of changeable input variables and values thereof.

In the first embodiment, the input variables X1 to XN can be applied to both a qualitative variable having a nominal scale or an order scale, and a continuous variable having an interval scale or a proportional scale. Although the prediction model PMam is a neural network model, the prediction model PMam is not limited thereto. For example, a prediction model such as a logistic regression model, a random forest model, or a Bayesian network model may be applied.

In addition, in step S402, the value of the number of repeated times m is set to be from 1 to M in increments of 1, but the present invention is not limited thereto. For example, it is possible to set an increment width of 2 or more. In this case, the number of required prediction models PMam can be reduced to a value obtained by dividing M by the increment width.

In addition, as shown in FIG. 9, the temporal variation information 700 is represented by a line graph, but the present invention is not limited thereto, and for example, a table format may be used. Furthermore, although the decision-making support apparatus 100 sets only the intervention measure Pt that matches the setting range of the temporal variation score SCt as a target of the result display, the present invention is not limited thereto. For example, the decision-making support apparatus 100 can determine the rank of the improvement effect ranking in consideration of both the improvement effect on the improvement effect ranking display area 801 and a degree of matching with the setting range of the temporal variation score SCt.

### Second Embodiment

A second embodiment is an example in which the temporal variation information 700 in the first embodiment is changed to a confidence interval of an outcome prediction value group (y1t, y2t, . . . , and yKt). In the second embodiment, differences from the first embodiment will be mainly described, and description of the same contents as those of the first embodiment will be omitted.

The prediction model DB 212 of the second embodiment stores K (K is an integer of 2 or more) prediction models PMb1 to PMbK with different training data. That is, learning parameters of the prediction models PMb1 to PMbK are different, and different output data is obtained when the same input data is given. In a case where the prediction models PMb1 to PMbK are not distinguished from each other, they are expressed as a prediction model PMbk (k is an integer satisfying 1≤k≤K). The training data of the prediction model PMbk is, for example, a bootstrap sample restored and extracted from original training data.

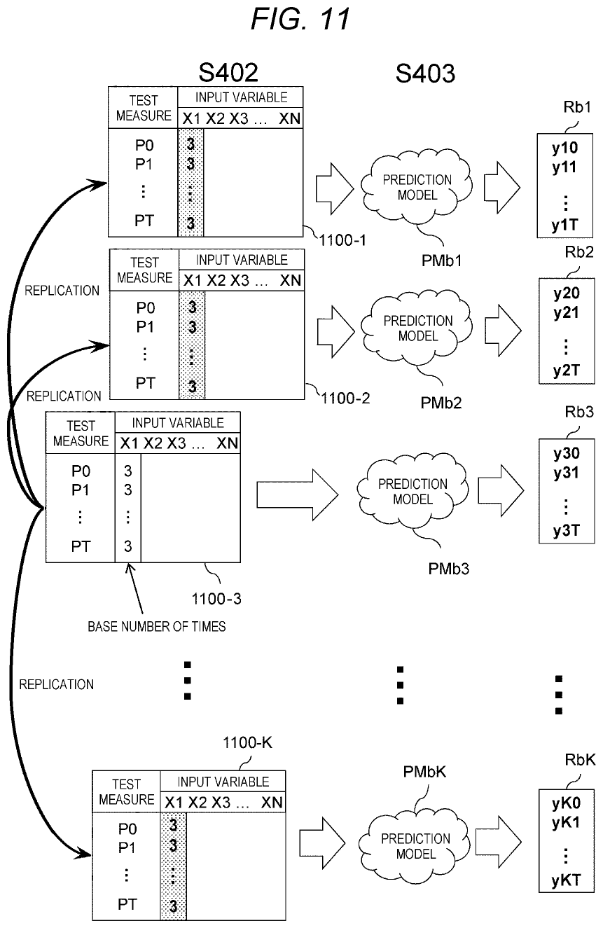

FIG. 11 is a diagram showing a processing example of step S402 and step S403 according to the second embodiment.

Step S402: The decision-making support apparatus 100 causes the replication unit 202 to replicate all entries of the serialized test measures 301 (P0 to PT) in (K−1) pieces of test measure data, so as to obtain test measure data 1100-1, 1100-2, 1100-4, . . . , and 1100-K. Unlike the first embodiment, the number of repeated times, which is a value of the input variable X1, is not changed for each of the test measure data 1100-1, 1100-2, 1100-4, . . . , and 1100-K. That is, in the test measure data 1100-1, 1100-2, 1100-4, . . . , and 1100-K, the value of the input variable X1 is the base number of times m=3.

Step S403: The decision-making support apparatus 100 causes the prediction unit 203 to acquire the K prediction models PMb1 to PMbK from the prediction model DB 212, and to sequentially input the K pieces of test measure data 1100-1 to 1100-K to the respective prediction models PMb1 to PMbK. Then, the decision-making support apparatus 100 causes the prediction unit 203 to acquire K outcome prediction value groups Rb1 to RbK sequentially predicted from the K prediction models PMb1 to PMbK. The decision-making support apparatus 100 causes the prediction unit 203 to group the K outcome prediction value groups Rb1 to RbK for each measure Pt.

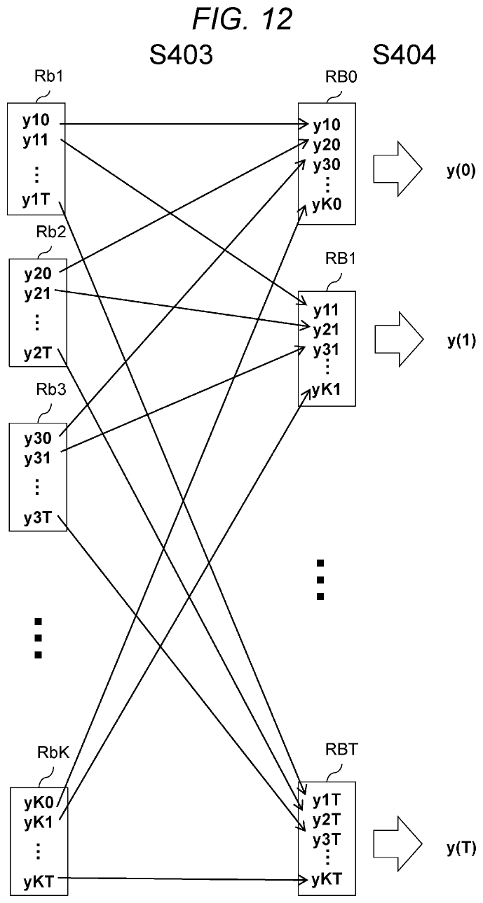

FIG. 12 is a diagram showing an example of grouping of the K outcome prediction value groups Rb1 to RbK. The K outcome prediction value groups Rb1 to RbK are grouped into (T+1) outcome prediction value groups RB0 to RBT collected for each measure Pt. The outcome prediction value group RB0 is a set of outcome prediction values y10 to yK0 of the baseline measure P0. The outcome prediction value group RBt is a set of outcome prediction values y1t to yKt of the intervention measures Pt.

Step S404: The decision-making support apparatus 100 causes the prediction unit 203 to sequentially calculate average values y(0), y(1), . . . , and y(T) for each of the (T+1) outcome prediction value groups RB0 to RBT. Then, the decision-making support apparatus 100 sequentially calculates differences between the average values y(0), y(1), . . . , and y(T) of the (T+1) outcome prediction value groups RB0 to RBT and the average value y(0) of the outcome prediction value of the baseline measure P0. In a case where the average values y(0), y(1), . . . , and y(T) are not distinguished from each other, they are expressed as an average value y(t).

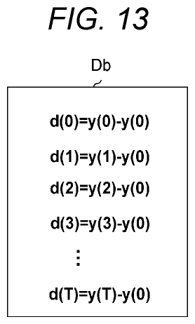

FIG. 13 is a diagram showing an example of difference data according to the second embodiment. Difference data Db includes (T+1) differences d(0) to d(T). In a case where the differences d(0) to d(T) are not distinguished from each other, they are expressed as a difference d(t). The difference data Db is used for improvement effect ranking, which will be described later.

Step S405: The decision-making support apparatus 100 causes the calculation unit 204 to calculate additional information for each of the (T+1) outcome prediction value groups RB0 to RBT. The additional information of the outcome prediction value group RBt is a confidence interval in the outcome prediction value group RBt and a confidence interval score. The confidence interval of each measure Pt is, for example, a range from a 5-percentile to a 95-percentile of the K outcome prediction values y1t to yKt in the outcome prediction value group RBt. The confidence interval score of each measure Pt is calculated by (A−B), for example, where A is an upper limit and B is a lower limit of the confidence interval of the measure Pt.

Step S408: The decision-making support apparatus 100 acquires a range of the confidence interval input by the user via the input device 103 in step S407. The decision-making support apparatus 100 causes the display control unit 205 to generate and display prediction information based on the acquired range of the confidence interval (step S406). The decision-making support apparatus 100 stores the prediction information in the storage device 102.

Specifically, for example, the decision-making support apparatus 100 causes the display control unit 205 to display, on the prediction result display area 803, a confidence interval based on the outcome prediction value group RBt (y1t, y2t, . . . , and yKt) for the intervention measure Pt of a rank selected by the user (first improvement measure Pt) (hereinafter, referred to as a confidence interval of the selected intervention measure Pt) in the improvement effect ranking together with a confidence interval based on the outcome prediction value group RB0 (y10, y20, . . . , and yK0) for the baseline measure P0 (hereinafter, referred to as a confidence interval of the baseline measure P0).

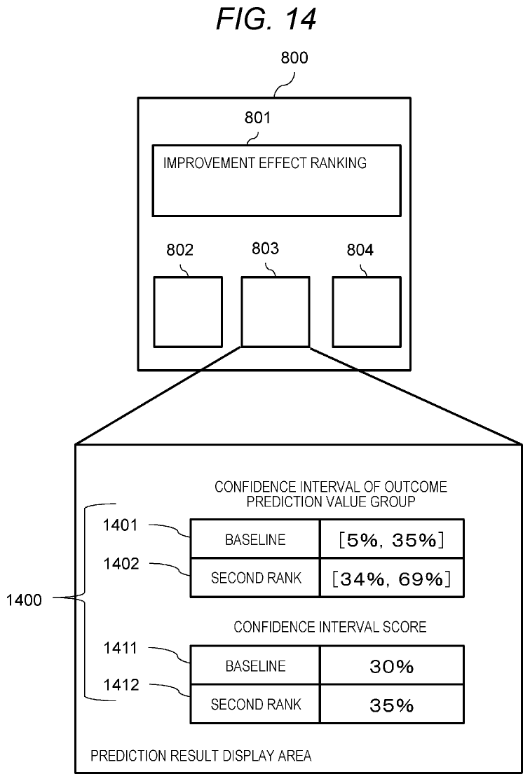

FIG. 14 is a diagram showing a second display example of the prediction result display area 803. In the prediction result display area 803, confidence interval information 1400 includes a confidence interval 1401 of the baseline measure P0, a confidence interval 1402 of the selected intervention measure Pt, a confidence interval score 1411 of the baseline measure P0, and a confidence interval score 1412 of the selected intervention measure Pt which is a first score. In FIG. 14, in the improvement effect ranking, the confidence interval 1402 of the second-ranked selected intervention measure Pt selected by the user and the confidence interval score 1412 which is the first score are displayed.

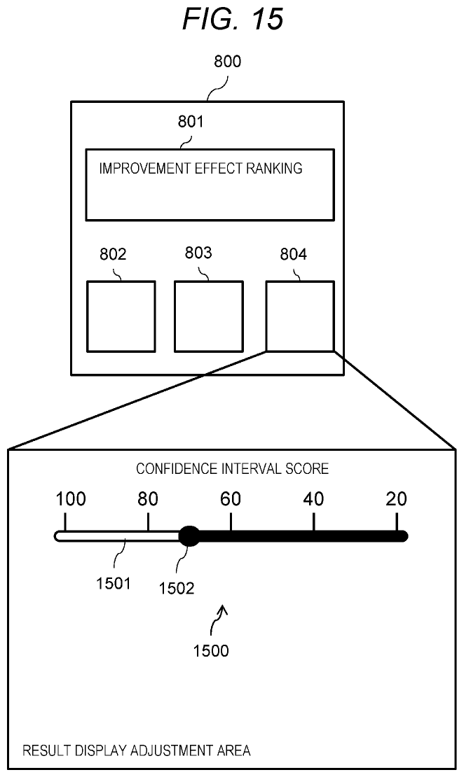

FIG. 15 is a diagram showing a second display example of the result display adjustment area 804. In the result display adjustment area 804, a user interface 1500 is displayed that enables adjustment of the confidence interval score 1412 of the selected intervention measure Pt, which is the first score. The user interface 1500 includes a numerical axis 1501 and a slider 1502.

The numerical axis 1501 is a slider bar having 20% at a right end and 100% at a left end. The slider 1502 is movable on the numerical axis 1501 by the operation of the input device 103 by the user. A default position of the slider 1502 is 100%. The position of 100% corresponds to the confidence interval score 1412 of the selected intervention measure Pt. Since a percentage value indicated by the slider 1502 decreases as the slider 1502 is moved to the right, the confidence interval score 1412 also decreases. A range from 20% to a percentage indicating the current position of the slider 1502 is a score range (indicated by a black thick line on the numerical axis 1501 in FIG. 15).

The improvement effect of the intervention measure Pt having the confidence interval score 1412 within the score range is selected as a display target in the improvement effect ranking display area 801. In the example of FIG. 15, since the slider 1502 is positioned at 70% of the numerical axis 1501, a range indicated by black from 20% to 70% is set as the score range.

That is, the decision-making support apparatus 100 causes the display control unit 205 to set the improvement effect (second improvement effect) of the intervention measure Pt (second intervention measure Pt) having the confidence interval score 1102 equal to or less than the numerical value of the current position of the slider 1302 as the display target of the improvement effect ranking display area 801. Therefore, as the user moves the slider 1302 to the right, the number of intervention measures Pt displayed in the improvement effect ranking display area 801 decreases. As a result, the displayed intervention measure Pt is the intervention measure Pt having the confidence interval score 1202 smaller than that of the intervention measure Pt which is not displayed, that is, having high reliability.

In addition, since a third intervention measure Pt corresponding to the confidence interval score 1102 outside the score range indicated by black is not displayed, the number of options when selecting the intervention measure Pt is reduced, and the burden on the user is reduced.

In addition, in a case where the number of rankings to be displayed is set in advance, the decision-making support apparatus 100 may automatically perform score adjustment in accordance with the number of displayed rankings, and output the adjustment result as the score range of the confidence interval score 1102.

As described above, in the decision-making support apparatus 100 according to the second embodiment, the prediction result of the intervention measure Pt that matches these conditions is displayed when the user sets the range of the confidence interval score 1202 that is the additional information. That is, the user can confirm the reliability of the intervention measure Pt by using two evaluation items, i.e., the outcome prediction value group (y1t, y2t, . . . , and yKt) and the confidence interval score 1202. This makes it possible to select an optimum intervention measure Pt even when there are a large number of changeable input variables and values thereof.

The second embodiment is also applicable to a case where there is no time-related variable among the input variables X1 to XN of the intervention measure Pt and the prediction model PMbk. As in the first embodiment, the prediction model PMbk is not limited to a neural network model. It is desirable that the prediction model PMbk is a model in which the confidence interval of the outcome prediction value can be calculated using an analytical method such as matrix calculation or a statistical method such as bootstrap.

### Third Embodiment

A third embodiment is an example in which the temporal variation information 700 in the first embodiment is changed to a latent variable of an outcome prediction value group. In the third embodiment, differences from the first embodiment will be mainly described, and description of the same contents as those of the first embodiment will be omitted.

The prediction model DB 212 of the third embodiment stores, for example, a partial least-squares regression model as a prediction model. The partial least-squares regression model is a model that predicts an outcome prediction value using mutually uncorrelated latent variables obtained by aggregating the input variables X1 to XN. It is assumed that the number of latent variables is, for example, six for each measure Pt, and interpretation of the meaning of each latent variable is completed in advance.

Step S402: Unlike the first embodiment, the decision-making support apparatus 100 does not replicate the test measure data 300-3, and directly proceeds to step S403.

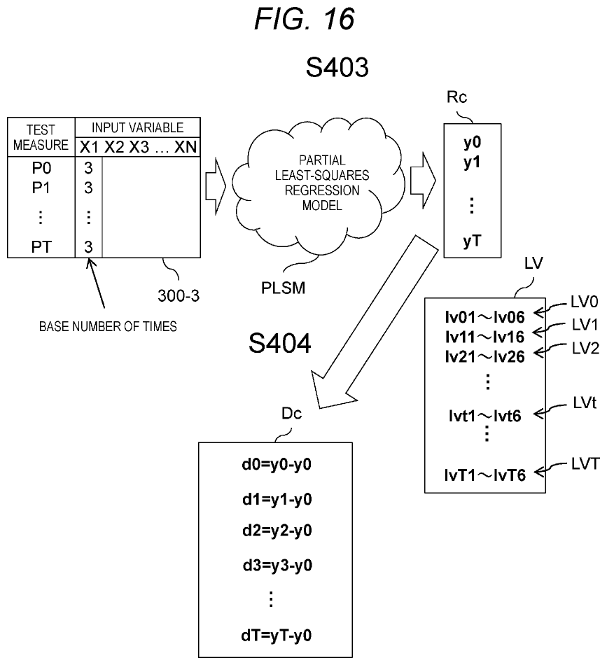

FIG. 16 is a diagram showing a processing example of step S403 and step S404 according to the third embodiment.

Step S403: The decision-making support apparatus 100 acquires a partial least-squares regression model PLSM as the prediction model from the prediction model DB 212, and sequentially inputs the test measure data 300-3 to the partial least-squares regression model PLSM. Then, the decision-making support apparatus 100 acquires a latent variable score LV and an outcome prediction value group Rc sequentially predicted from the partial least-squares regression model PLSM.

The outcome prediction value group Rc includes outcome prediction values y0, y1, . . . , and yT of the baseline measure P0 and the intervention measures P1, P2, . . . , and PT. The latent variable score LV includes latent variable scores LV0 to LVT of the baseline measure P0 and the intervention measures P1, P2, . . . , and PT. In a case where the latent variable scores LV0 to LVT are not distinguished from each other, they are expressed as a latent variable score LVt. The latent variable score LVt includes six latent variables lvt1 to lvt6. In a case where the latent variables lvt1 to lvt6 are not distinguished from each other, they are expressed as a latent variable lvt. It is assumed that the latent variable lvt is scaled from 0% to 100% based on training data.

Step S404: The decision-making support apparatus 100 sequentially calculates differences d0 to dT between the outcome prediction value y0 of the baseline measure P0 and the outcome prediction values y0, y1, . . . , and yT of the baseline measure P0 and the intervention measures P1, P2, . . . , and PT, and sets the differences d0 to dT as difference data Dc.

Step S405: Unlike the first embodiment, the decision-making support apparatus 100 causes the calculation unit 204 to acquire the latent variable score LV as additional information.

Step S406: The decision-making support apparatus 100 acquires a range of the latent variable lvt input by the user via the input device 103. The decision-making support apparatus 100 generates and displays prediction information based on the acquired range of the latent variable lvt. The decision-making support apparatus 100 stores the output prediction information in the storage device 102.

The decision-making support apparatus 100 causes the display control unit 205 to display, on the prediction result display area 803, the latent variable score LV of a rank for which a first improvement effect is selected by the user in the improvement effect ranking, as the first score.

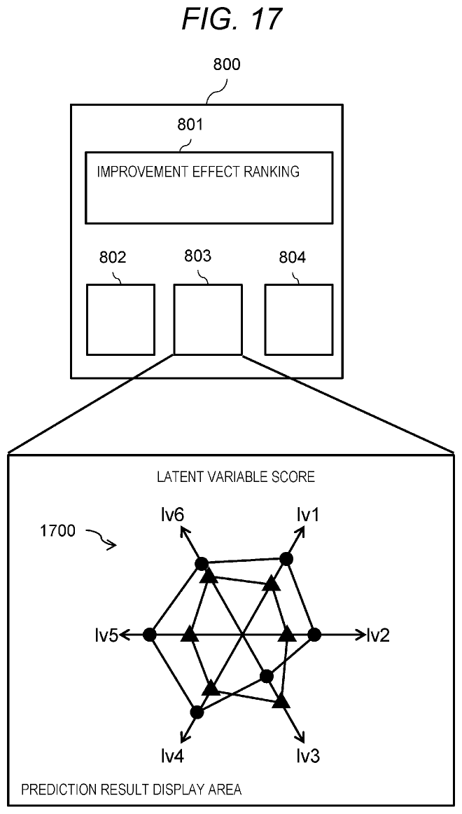

FIG. 17 is a diagram showing a third display example of the prediction result display area 803. In the prediction result display area 803, a radar chart 1700 is a graph expressed by a plurality of axes (six axes in this example) in a circumferential direction, and the values of the six latent variables lvt1 to lvt6 are visualized. In the radar chart 1700, black circles indicate the latent variables lvt1 to lvt6 of the intervention measure Pt (first intervention measure Pt) for which the first improvement effect is selected, and black triangles indicate latent variables lv01 to lv06 of the baseline measure P0 as a comparative reference. Although the latent variables lvt1 to lvt6 are represented by the radar chart 1700 here, the present invention is not limited thereto, and the latent variables lvt1 to lvt6 may be, for example, in a table format.

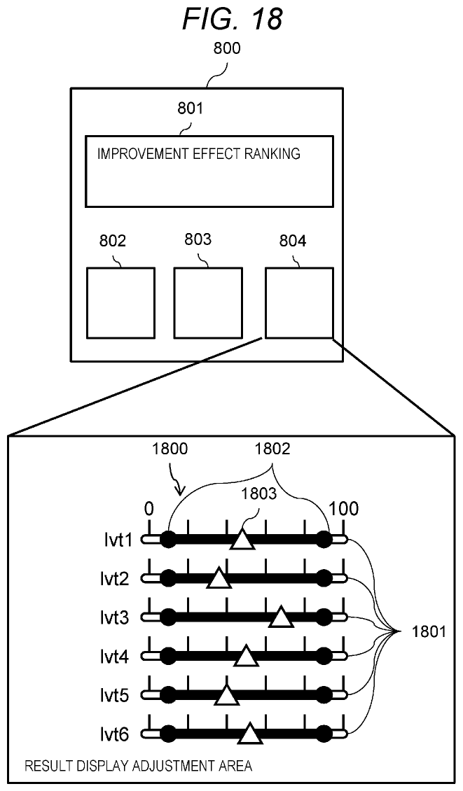

FIG. 18 is a diagram showing a third display example of the result display adjustment area 804. In the result display adjustment area 804, a user interface 1800 is displayed that enables adjustment of the latent variable score LV. The user interface 1800 includes a numerical axis 1801 and a slider 1802 indicated by a black circle for each of the latent variables lvt1 to lvt6.

The slider 1802 is an example of an adjustment unit to be displayed on the result display adjustment area 804, and sets the range of the latent variable score LV in the third embodiment. FIG. 18 is an example in which the ranges of all the latent variables lvt1 to lvt6 are set to a score range from 10% to 90% (indicated by a black thick line on the numerical axis 1801 in FIG. 18). In this case, it is assumed that all measures Pt satisfy the condition and are displayed in the improvement effect ranking. The position of 100% corresponds to the latent variables lvt1 to lvt6 of the selected intervention measure Pt.

White triangles are latent variables lv01 to lv06 of the baseline measure P0. When the user moves the two sliders 1802 of the latent variable lvt to the left and right, the decision-making support apparatus 100 selects the improvement effect (second improvement effect) of the intervention measure Pt (second intervention measure Pt) having, as a second score, the latent variable lvt within the score range designated by positions of the sliders 1802, as the display target in the improvement effect ranking display area 801.

Therefore, as the user moves the range of the two sliders 1802 of the latent variable lvt to the right side, the number of the second intervention measures Pt displayed in the improvement effect ranking display area 801 decreases, and these second improvement effects are improvement effects of only the intervention measure Pt having a higher latent variable lvt, that is, having a higher improvement effect than the improvement effect of a third intervention measure Pt corresponding to the latent variables lvt1 to lvt6 outside the score range.

The range of the latent variable lvt can be independently set for each of the six latent variables lvt1 to lvt6. That is, it is possible to perform adjustment such as preferentially displaying a specific intervention measure Pt having a high latent variable lvt or preferentially hiding a specific intervention measure Pt having a low latent variable lvt.

In addition, since a third intervention measure Pt corresponding to the latent variables lvt1 to lvt6 outside the score range indicated by black is not displayed, the number of options when selecting the intervention measure Pt is reduced, and the burden on the user is reduced.

In addition, in a case where the number of rankings to be displayed is set in advance, the decision-making support apparatus 100 may automatically perform score adjustment in accordance with the number of displayed rankings, and output the adjustment result as the score range of the latent variable score LV.

As described above, in the decision-making support apparatus 100 according to the third embodiment, only the improvement effect of the intervention measure Pt that matches these conditions is displayed when the user sets the range of the latent variable lvt that is the additional information. That is, the explanation of the intervention measure Pt can be confirmed using two evaluation items, i.e., the outcome prediction value yt and the latent variable lvt. This allows the user to select an optimum intervention measure Pt even when there are a large number of changeable input variables X1 to XN and values thereof. As in the first embodiment, the third embodiment is also applicable to a case where there is no time-related variable in the input variables of the test measure and the prediction model.

In the third embodiment, the partial least-squares regression model PLSM is used as the prediction model, but the prediction model is not limited thereto. For example, a prediction model that can interpret a latent variable, such as a principal component regression model or a structure equation model can be applied. Although the number of latent variables to be used is six, the present invention is not limited thereto. In general, as the number of latent variables to be used increases, the prediction accuracy of the prediction model is improved, and the improvement converges at a certain number or more. Therefore, the number of latent variables to be used may be, for example, near the convergence point of the prediction accuracy.

### Fourth Embodiment

A fourth embodiment is an example including all functions described in the first to third embodiments. The decision-making support apparatus 100 stores, in the prediction model DB 212, the M prediction models PMa1 to PMaM described in the first embodiment, the K prediction models PMb1 to PMbK described in the second embodiment, and the prediction model having the latent variable and described in the third embodiment (for example, a partial least-squares regression model PLSM).

The decision-making support apparatus 100 executes an outcome prediction using these prediction models PMam, PMbk, and PLSM. There are three types of outcome prediction results for each of the prediction models PMam, PMbk, and PLSM, and the decision-making support apparatus 100 employs, for example, a method of calculating the average value y(t) of the outcome prediction values based on the prediction model PMbk according to the second embodiment.

The decision-making support apparatus 100 further acquires additional information for each measure Pt from the prediction models PMam, PMbk, and PLSM. The decision-making support apparatus 100 displays the additional information on the prediction information display screen 800 (step S406), and changes the display content of the improvement effect ranking based on each range of the additional information set by the user operation (step S407: Yes) (step S408). There are three types of additional information and range adjustment units for the additional information for each of the prediction models PMam, PMbk, and PLSM. Therefore, the decision-making support apparatus 100 displays the prediction information by appropriately switching the prediction information display screen 800, for example.

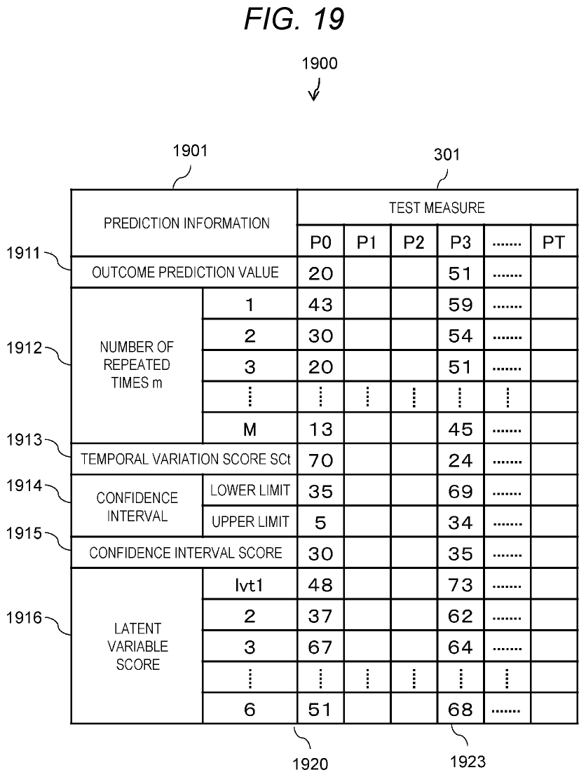

FIG. 19 is a diagram showing an example of prediction result data obtained by the decision-making support apparatus 100 according to the fourth embodiment. Prediction result data 1900 is a table having an outcome prediction value 1911, a number of repeated times 1912, a temporal variation score 1913, a confidence interval 1914, a confidence interval score 1915, and a latent variable score 1916 for each measure Pt.

In FIG. 19, the intervention measure P3 is an intervention measure selected as a second rank of the improvement effect ranking, and the numerical values shown in FIGS. 8, 9, 10, 14, 15, 17, and 18 are stored. Values of column data of the intervention measures P1, P2, and P4 to PT other than column data 1923 of the intervention measure P3 and column data 1920 of the baseline measure are blank for convenience of description, but actually have individual values.

In addition, in the fourth embodiment, the decision-making support apparatus 100 capable of executing processes related to the functions of the first to third embodiments has been described as an example, but the decision-making support apparatus 100 capable of executing the processes related to the functions of two embodiments of the first to third embodiments may be used.

In the first to third embodiments, the decision-making support apparatus 100 displays the prediction information display screen 800, and the user sets the range of values of various types of additional information, but the present invention is not limited thereto. For example, the decision-making support apparatus 100 may display the range of the additional information effective for the intervention measure Pt as a recommendation based on a set of the intervention measure Pt and the additional information thereof stored in the storage device 102 in advance, and the user may set the range based on the information.

For example, in a case where the number of intervention measures Pt is equal to or greater than a threshold value, or in a case where the difference in the improvement effect for each intervention measure Pt is within a predetermined range, the decision-making support apparatus 100 may consider a method of recommending a setting that narrows the range of values of the additional information. A recommendation presentation operation can be implemented by, for example, the decision-making support apparatus 100 executing a program according to conditions. Alternatively, the recommendation presentation operation can also be implemented by the decision-making support apparatus 100 learning past setting information of the user and presenting setting information close to the current condition.

As described above, according to the decision-making support apparatus 100 of the first to fourth embodiments described above, in a case where there are a large number of changeable input variables and values thereof, even in a case where a large number of prediction results are displayed, it is possible to select an intervention measure based on the predicted improvement effect of the intervention measure by the discretion of the user himself/herself.

In the decision-making support apparatus 100 according to the first to fourth embodiments described above, the prediction unit 203 acquires the outcome prediction value using the prediction model, but the decision-making support apparatus 100 may acquire the outcome prediction value (including the latent variable in the case of the third embodiment) from an external device capable of communicating with the decision-making support apparatus 100.

The invention is not limited to the above embodiment and includes various modifications and equivalent configurations within the spirit of the claims. For example, the above-mentioned embodiments are described in detail for a better understanding of the invention, and the invention is not necessarily limited to those including all the configurations described above. Further, a part of the configurations according to a given embodiment may be replaced by the configurations according to another embodiment. Further, the configurations according to another embodiment may be added to the configurations according to a given embodiment. Furthermore, a part of the configurations according to each embodiment may be added to, deleted from, or replaced by another configuration.

In addition, the above-mentioned configurations, functions, processing units, processing measures and the like may be realized partly or entirely by hardware, for example, by designing an integrated circuit, and may be realized partly or entirely by software by causing a processor to interpret and execute programs that implement those functions.

The information of programs, tables, and files, and the like to implement the functions may be stored in a storage device such as a memory, a hard disk, or a solid state drive (SSD), or a storage medium such as an integrated circuit (IC) card, an SD card, and a digital versatile disc (DVD).

Further, control lines and information lines indicate what is considered necessary for description, and not all control lines and information lines in a product are shown. It can be considered that almost all components are actually interconnected.

What is claimed is:

1. A decision-making support apparatus comprising:
a processor configured to execute a program; and
a storage device configured to store the program, wherein
the storage device is configured to store a score serving as a relative index between a plurality of intervention measures for each of the intervention measures, and
the processor is configured to execute
a selection process of receiving selection of a first improvement effect among a plurality of improvement effects related to the plurality of intervention measures,
a first output process of outputting, within an adjustment range based on a first score of a first intervention measure for which the first improvement effect is selected by the selection process, adjustable information of the first score,
an input process of receiving a score range set by an adjusted first score within the adjustment range, and
a second output process of outputting, among the plurality of improvement effects, a second improvement effect of a second intervention measure having a second score included in the score range received by the input process.

2. The decision-making support apparatus according to claim 1, wherein
in the second output process, the processor does not output, among the plurality of improvement effects, a third improvement effect of a third intervention measure having a third score not included in the score range.

3. The decision-making support apparatus according to claim 1, wherein
an upper limit of the adjustment range corresponds to the first score before adjustment.

4. The decision-making support apparatus according to claim 1, wherein
the storage device stores a time-series prediction result group for each intervention measure,
the processor executes a calculation process of calculating, based on the time-series prediction result group for each intervention measure, the score related to a temporal variation of the time-series prediction result group for each intervention measure,
in the first output process, the processor outputs adjustable information of the first score within an adjustment range based on the first score related to a temporal variation of a first time-series prediction result group of the first intervention measure, and
in the second output process, the processor outputs, among the plurality of improvement effects, a second improvement effect of the second intervention measure having the second score included in the score range and related to a temporal variation of a second time-series prediction result group of the second intervention measure.

5. The decision-making support apparatus according to claim 4, wherein
the storage device stores the time-series prediction result group for each intervention measure and a time-series prediction result group of a baseline measure serving as a reference for the plurality of intervention measures, and
the processor executes a third output process of outputting the first time-series prediction result group of the first intervention measure and the time-series prediction result group of the baseline measure when the first improvement effect is selected by the selection process.

6. The decision-making support apparatus according to claim 1, wherein
the processor executes a calculation process of calculating, based on a time-series prediction result group for each intervention measure, the score related to a confidence interval of the time-series prediction result group for each intervention measure,
in the first output process, the processor outputs, within an adjustment range based on the first score related to a confidence interval of a first time-series prediction result group of the first intervention measure, adjustable information of the first score, and
in the second output process, the processor outputs, among the plurality of improvement effects, a second improvement effect of the second intervention measure having the second score included in the score range and related to a confidence interval of a second time-series prediction result group of the second intervention measure.

7. The decision-making support apparatus according to claim 6, wherein
the storage device stores the time-series prediction result group for each intervention measure and a time-series prediction result group of a baseline measure serving as a reference for the plurality of intervention measures, and
the processor executes a third output process of outputting the confidence interval of the first time-series prediction result group of the first intervention measure and a confidence interval of the time-series prediction result group of the baseline measure when the first prediction result is selected by the selection process.

8. The decision-making support apparatus according to claim 6, wherein
the storage device stores the time-series prediction result group for each intervention measure and the time-series prediction result group of the baseline measure serving as a reference for the plurality of intervention measures, and
the processor executes a third output process of outputting the first score related to the confidence interval of the first time-series prediction result group of the first intervention measure and the score related to the confidence interval of the time-series prediction result group of the baseline measure when the first prediction result is selected by the selection process.

9. The decision-making support apparatus according to claim 1, wherein
the storage device stores a time-series prediction result group for each intervention measure and stores, as the score, a latent variable of a prediction model that outputs the prediction result group,
in the first output process, the processor outputs, within an adjustment range based on a first latent variable of the first intervention measure, adjustable information of the first latent variable, and
in the second output process, the processor outputs, among the plurality of improvement effects, a second improvement effect of the second intervention measure having a second latent variable included in the score range and related to a second time-series prediction result group of the second intervention measure.

10. The decision-making support apparatus according to claim 9, wherein
the prediction model is any one of a partial least-squares regression model, a principal component regression model, and a structure equation model.

11. The decision-making support apparatus according to claim 9, wherein
the storage device stores a latent variable for each intervention measure and a latent variable of a baseline measure serving as a reference for the plurality of intervention measures, and
the processor executes a third output process of outputting the first latent variable of the first intervention measure and the latent variable of the baseline measure when the first improvement effect is selected by the selection process.

12. The decision-making support apparatus according to claim 11, wherein
in the third output process, the processor outputs the first latent variable of the first intervention measure and the latent variable of the baseline measure in a graph expressed by a plurality of axes in a circumferential direction.

13. A decision-making support method by a decision-making support apparatus, the decision-making support apparatus including a processor configured to execute a program and a storage device configured to store the program, the decision-making support method comprising:
causing the storage device to store a score serving as a relative index between a plurality of intervention measures for each of the intervention measures; and
causing the processor to execute:
a selection process of receiving selection of a first improvement effect among a plurality of improvement effects related to the plurality of intervention measures;
a first output process of outputting, within an adjustment range based on a first score of a first intervention measure for which the first improvement effect is selected by the selection process, adjustable information of the first score;
an input process of receiving a score range set by an adjusted first score within the adjustment range; and
a second output process of outputting, among the plurality of improvement effects, a second improvement effect of a second intervention measure having a second score included in the score range received by the input process.

14. A decision-making support program that causes a processor configured to access a storage device that stores a score serving as a relative index between a plurality of intervention measures for each of the intervention measures to execute:
a selection process of receiving selection of a first improvement effect among a plurality of improvement effects related to the plurality of intervention measures;
a first output process of outputting, within an adjustment range based on a first score of a first intervention measure for which the first improvement effect is selected by the selection process, adjustable information of the first score;
an input process of receiving a score range set by an adjusted first score within the adjustment range; and
a second output process of outputting, among the plurality of improvement effects, a second improvement effect of a second intervention measure having a second score included in the score range received by the input process.
